(19) United States
(12) Patent Application Publication
(10) Pub. No.: US 2003/0127119 A1
(43) Pub. Date: Jul. 10, 2003

(54) Operating system for vehicle washing bay

(75) Inventor: Donald W. Scordo, Webster, NY (US)

Correspondence Address: Stephen B. Salai, Esq., Harter, Secrest & Emery LLP, 1600 Bausch & Lomb Place, Rochester, NY, 14604-2711, US

(73) Assignee: Washing Equipment Technologies, Inc., Rochester, NY (US)

(21) Appl. No.: 10/131,978

(22) Filed: Apr. 25, 2002

Related U.S. Application Data
(63) Continuation-in-part of application No. 29/153,567, filed on Jan. 9, 2002, now Pat. No. D470640.

(51) Int. Cl. B08B 3/00

(52) U.S. Cl. 134/57 R; 134/113; 134/123; 134/99.2; 134/100.1; 134/195

(57) ABSTRACT

In the present invention a car wash system is provided with a plurality of additive supplies, often referred to as solutions in the car wash industry, each supply feeding to a manifold including a common meter that has a value associated with each of the separate additive supplies for controlling flow from each of the supplies. A single variable speed pump under control of the computer pumps water through the meter and against the vehicle to be washed. The flow of the water through the meter aspirates additives from the supplies that mix with the water stream in the meter. Opening and closing of the valves to admit one or more of the additives to the water stream is responsive to a pre selected car wash cycle that is controllable by a controller.

### CROSS REFERENCE TO RELATED APPLICATIONS

This application claims priority to Design patent application No. 29/153,567 entitled SUPPORT STAND FOR SELF-SERVICE VEHICLE WASHING PUMP CONSOLE, filed Jan. 9, 2002.

### TECHNICAL FIELD

The present invention relates to automatic car washes and more particularly to an improved car wash system wherein the flow of water and the drawing of various additives, such as detergent and conditioners, among others, and the subsequent application to a vehicle is accomplished with a single pump.

### BACKGROUND OF THE INVENTION

Automatic car wash systems are known. In a common application, such as a self serve automatic car wash, the vehicle is driven into the wash bay, coins, tokens, credit cards or other methods that confirm payment, such as a number entered on a keypad, initiate car wash activity. The user then selects a desired car wash option/service from a menu. The car wash will then start and the user can manually sequence through various wash services/options until time runs out.

A standard car wash sequence involves directing water under pressure against the vehicle. Soap or detergent, hereafter used as a general term that includes soaps, surfactants, and other cleaning additives that are used in the car wash industry, is applied together with the water spray or as a separate application. The selected operational sequence also may involve the application of various other additives, such as surfactants, waxes, and the like often referred to as solutions in the car wash industry, together with the water spray. In operations known to one skilled in the art, the system for applying the detergent and the other additives each employ a dedicated pump separate and apart from the water pump used to direct water at the vehicle. Thus, in a conventional car wash operation, the drawing of additives from a supply requires controlling the operation of several pumps and valves.

Accordingly, the need exists for an automatic car wash system that simplifies the plumbing by eliminating the need for separate pumps for the water supply and each of the additives that may be used in any of the selected car wash options and automating the operation.

### SUMMARY OF THE INVENTION

In accordance with the present invention a car wash system is provided with a plurality of additive supplies, often referred to as solutions in the car wash industry, each supply feeding to a manifold including a common meter that has a valve associated with each of the separate additive supplies for controlling flow from each of the supplies. A single variable speed pump under control of the computer pumps water through the meter and against the vehicle to be washed. The flow of the water through the meter aspirates additives from the supplies that mix with the water stream in the meter. Opening and closing of the valves to admit one or more of the additives to the water stream is responsive to a pre selected car wash cycle that is controllable by a controller.

Accordingly, the present invention may be characterized by a car wash system comprising:

a) separate water and additive supplies;

b) a meter having a plurality of inlets for connection to each of the water and additive supplies and having an outlet;

c) a variable speed pump having a suction side connected to the meter outlet such that the pump is common to each of the separate water and additive supplies and the pump having an output side;

d) applicators connected to the pump output side for applying water and additives to an adjacent vehicle; and

e) a controller acting responsive to selected inputs to select the speed of the pump and control the entry of water and additives into the meter, whereby a single pump accounts for the drawing of water and additives from each of the supplies and the application of water and additives to a vehicle.

### DESCRIPTION OF THE DRAWINGS

In the detailed description of the preferred embodiments of the invention presented below, reference is made to the accompanying drawings.

FIG. 1 is a schematic drawing showing components of the car wash system.

FIG. 2 is a perspective view of the car wash system.

FIG. 3 is a perspective view of the frame.

FIG. 4 is a perspective view of another embodiment of the frame.

FIG. 5 is a perspective view of another embodiment of the frame.

FIG. 6 is a perspective view of the manifold.

FIG. 7 is a cross-sectional view of one channel of the manifold.

FIG. 8 is a top view of the manifold.

FIG. 9 is a cross-sectional view of the bottom manifold.

FIG. 10 is an end view of the manifold.

FIG. 11 is a perspective view of the mixing solution storage container.

FIG. 12 is a partial cut away of the top view of the mixing solution storage container.

FIG. 13 is partial cut away side view of the mixing solution storage container.

FIG. 14 is a bottom view of the view of the mixing solution storage container.

### DETAILED DESCRIPTION OF THE INVENTION

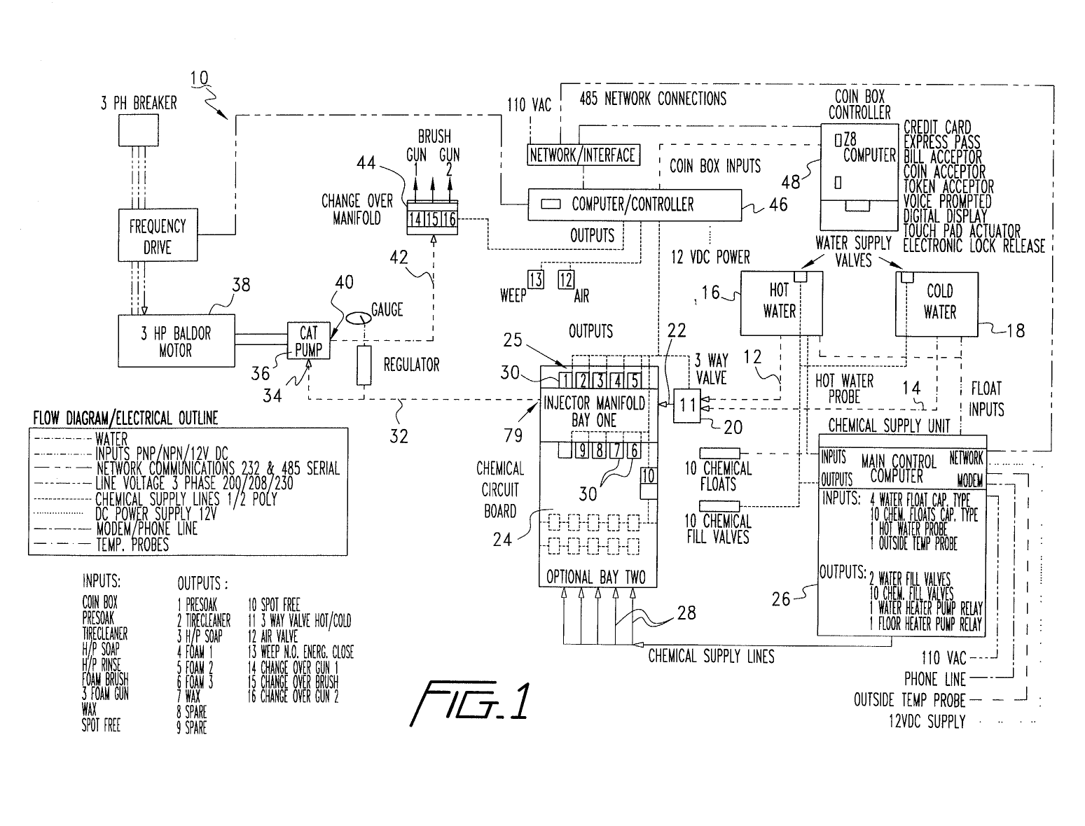

Referring to the drawings, FIG. 1 shows a car wash system generally indicated at 10 including a fluid circuit for delivering water and selected additives, often referred to as solutions in the car wash industry, against the vehicle to be washed and an electrical circuit controlling the operation of the system.

The fluid circuit includes pipes 12 and 14 connected to a source of hot and cold water 16 and 18 respectively. Generally a hot water heater (not shown) supplies the hot water to a temperature higher than the tap water which can supply the cold water pipe. The hot water can be around 110 degrees but could vary significantly in temperature as is well known in the art. The water pipes connect to inlets on a three-way valve 20, which could be a hot-cold water valve, with the outlet 22 of the valve being connected to a mixing manifold 24 that includes a chemical circuit board 25. Also connected to the mixing manifold are additive supplies, the additive supplies being collectively identified at 26 include, but are not limited to detergents (a term meant to include such additives such as soaps, surfactants, etc.), water, conditioners and waxes, among others. The additives are selectively introduced into the water stream as further set out hereinbelow.

Additive supply lines 28 extend from the individual additive supplies 26 to the mixing manifold 24. Metering valves 30 within the mixing manifold control flow through each of the additive supply lines 28. In the mixing manifold 24, the various additive valves 30 are selectively opened to mix a desired amount of the selected additive with the water entering the manifold. The mixture then leave the mixing manifold through a delivery line 32 that connects to the suction side 34 of a variable speed pump 36. A variable speed motor 38 drives the pump and pressure side 40 of the pump connects through a line 42 to a selected applicator 44. The applicator can be any one of a brush or spray gun applicator or other type of applicator suitable for a car wash application as is known in the art.

A controller 46, which can vary from hard-wired relays to a computer, as needed, controls operation of the car wash system. The controller initially receives input from a data source 48 such as a computer, voice recognition device, touch pad, credit card reader, expense press, electronic locking device, token, coin or bill acceptor or the like. The input represents a selection of a given car wash cycle together with confirmation of payment. Outputs from the controller 46 operate the three-way valve 20, the metering valves 30 and sets the operational speed of the motor 38 for driving the pump 36. Since the suction side 34 of the pump is connected to the mixing manifold, the operation of the pump acts to draw one or more additives from the supply 26 through any of the valves 30 that are open.

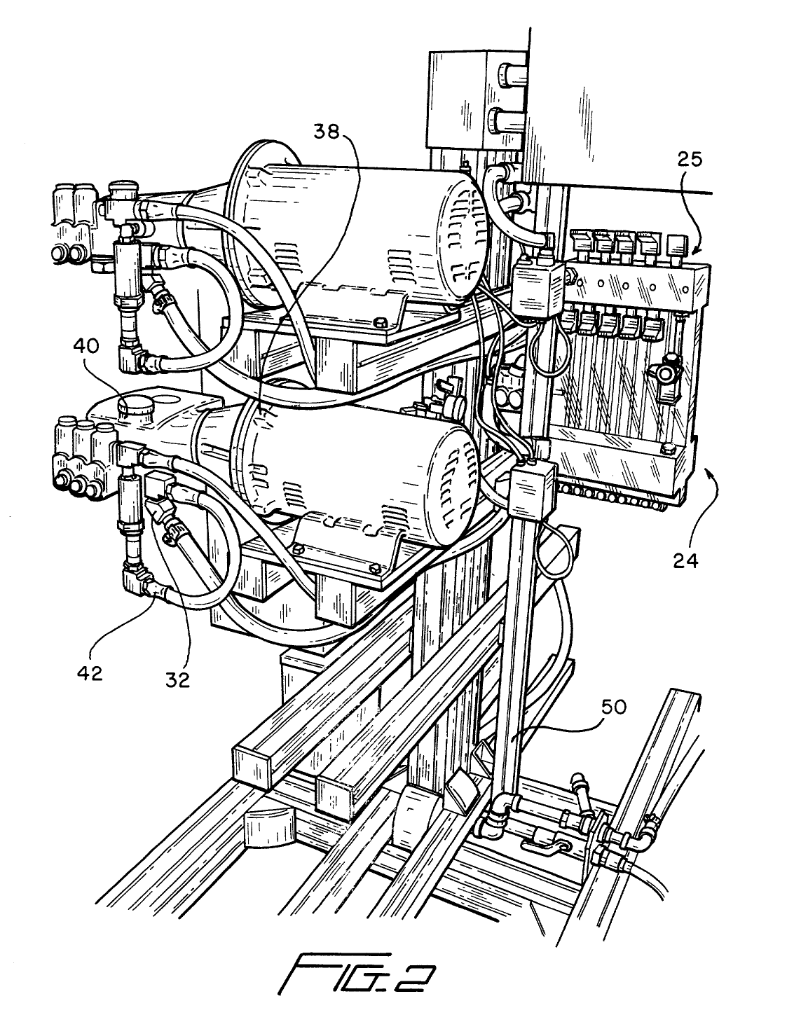

FIG. 2 shows a perspective view of the car wash system including the mixing manifold 24, and one or more motors 38, and one or more delivery lines 32 held on a frame 50. The motor 38 drives the pump and pressure side 40 of the pump connects through line 42 to the selected applicator 44. The applicator can be any one of a brush or spray gun applicator or other type of applicator suitable for a car wash application as is known in the art which can be connected to line 42 and transports or operates in conjunction with the fluid transported from the pump 40.

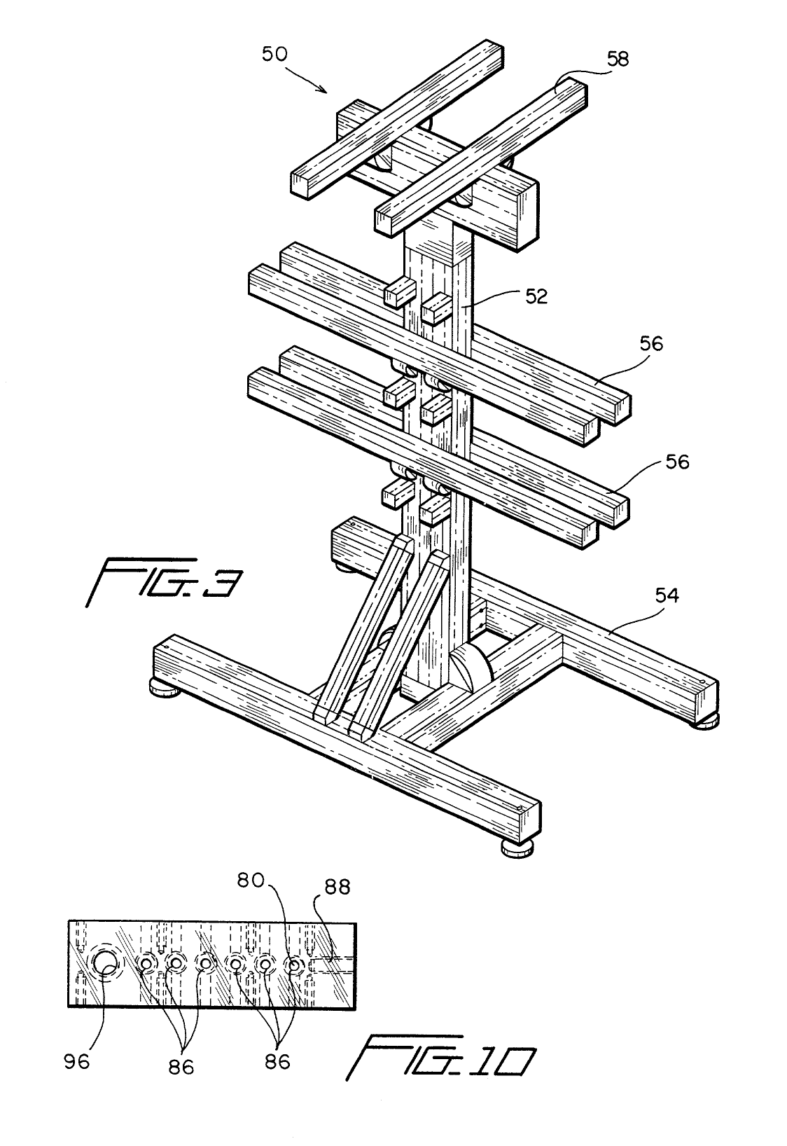

FIG. 3 is a perspective view of the frame 50 including an upright portion 52, a lower portion 54 to support the frame and various cross frame members 56 supported on the upright portions 52. There is also a top portion 58. FIG. 4 is a perspective view of another embodiment of a frame 60 including an upright portion 62, a lower portion 64 to support the frame and various cross frame members 66, of which there are three in this embodiment, supported on the upright portions 62. There is also a top portion 68. FIG. 5 is a perspective view of another embodiment of a frame 70 including an upright portion 72, a lower portion 74 to support the frame and various cross frame members 76, of which there are four in this embodiment, supported on the upright portions 72. There is also a top portion 78. This frame 50 is in one embodiment the actual plumbing. All of the above frame portions, which are aluminum extrusions, can be fluid conduits for the air, cold water and hot water. These conduits are capable of communication fluids, including fluid from the additive supplies to the manifold 24.

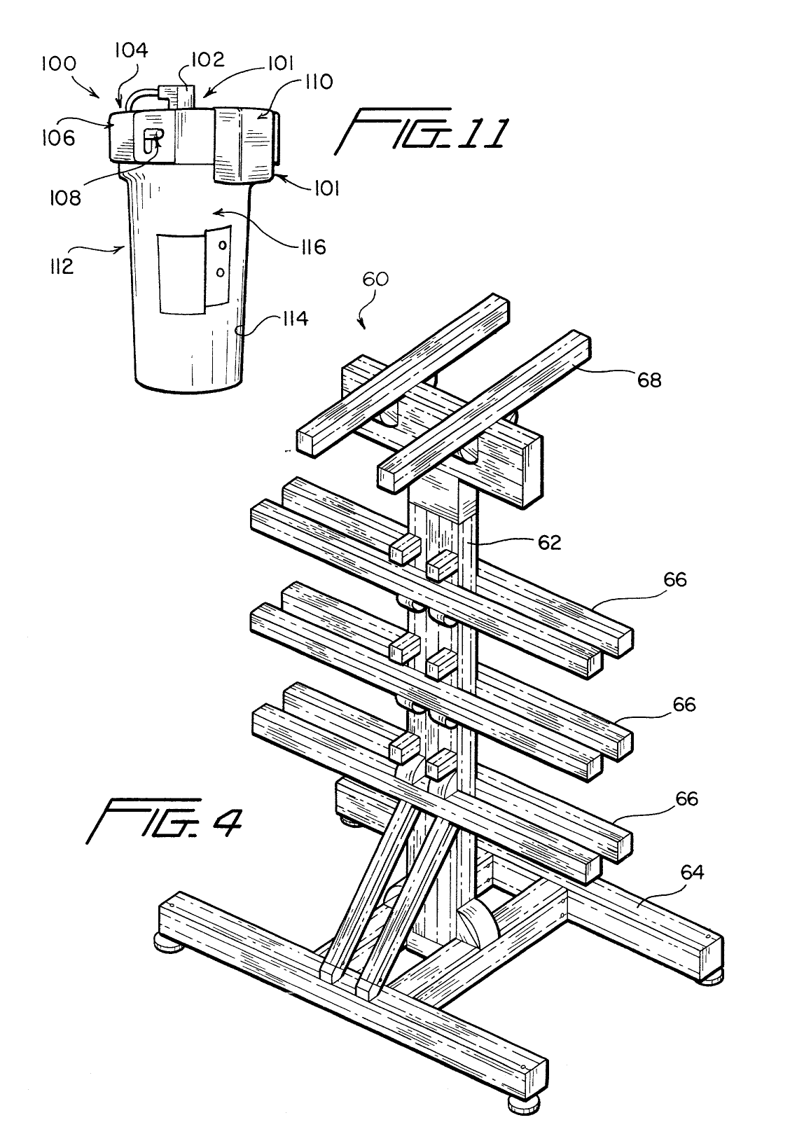

FIG. 6 shows a perspective view of the manifold 24 with the chemical circuit board 25 showing the three-way valve 20 in the lower left hand corner of FIG. 6 connected to the manifold via the valve outlet 22. The mixing manifold 24 can have one or more metering valves connected to the inlet valve 20 and an outlet port 79. In this example there are two rows of five metering valves 30 for a total of ten metering valves, for a first bay 81, connected to the chemical circuit board 25 which is used to convey the user-selected commands as to the cleaning additives necessary. Another embodiment has two sets of three metering valves for a total of six metering valves.

Also shown in FIG. 6 is a spot-free valve 80 that can be used to transport other fluids such as spot-free water, for mixing with the additives. This additional fluid could be the only fluid carrier or mixed in appropriate proportions with the other fluids(s) such as the hot and cold water. Note that there can be more than one mixing manifold 24 in the operating system, each for a different vehicle washing bay. These manifolds could operate independently or be piped together.

FIG. 7 shows a cross-sectional view of a longitudinal channel 82 of the manifold 24 showing four smaller bores 84 that intersect the longitudinal channel 82. There are also two end bores 86 that are adjacent and coincident with the longitudinal channel 82 and three tap holes 88 that do not intersect the longitudinal channel 82.

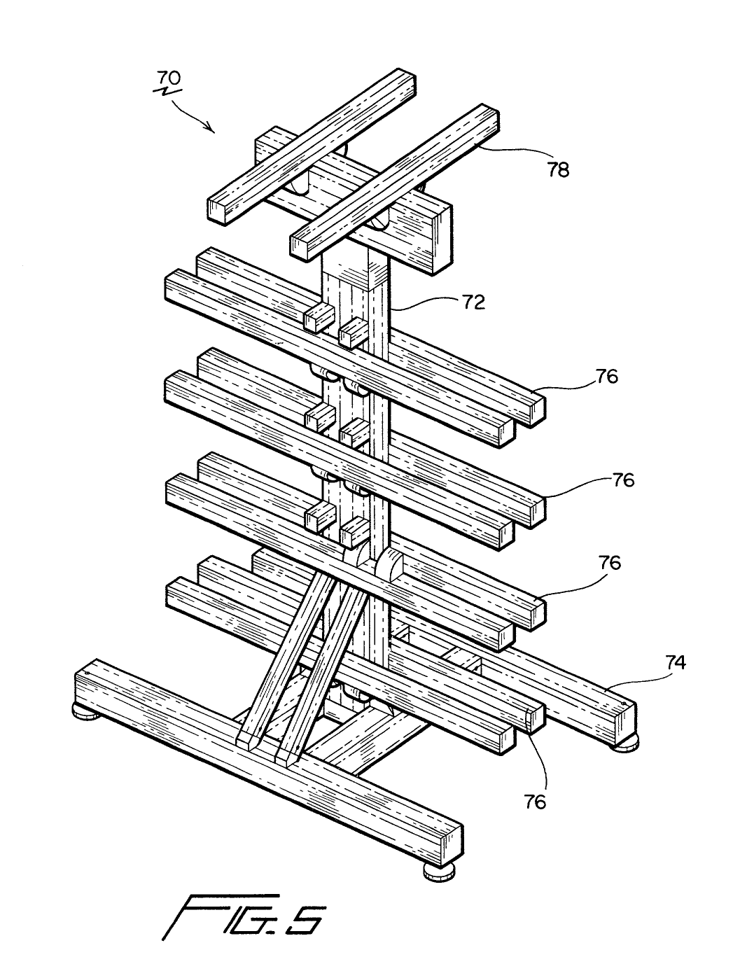

FIG. 8 is shows the top view of the manifold 24 with six longitudinal channels 82 and a number of tap holes 88 that do not intersect the longitudinal channels 82. Below the six longitudinal channels 82 is a base longitudinal channel 90 with four intersecting large bores 92.

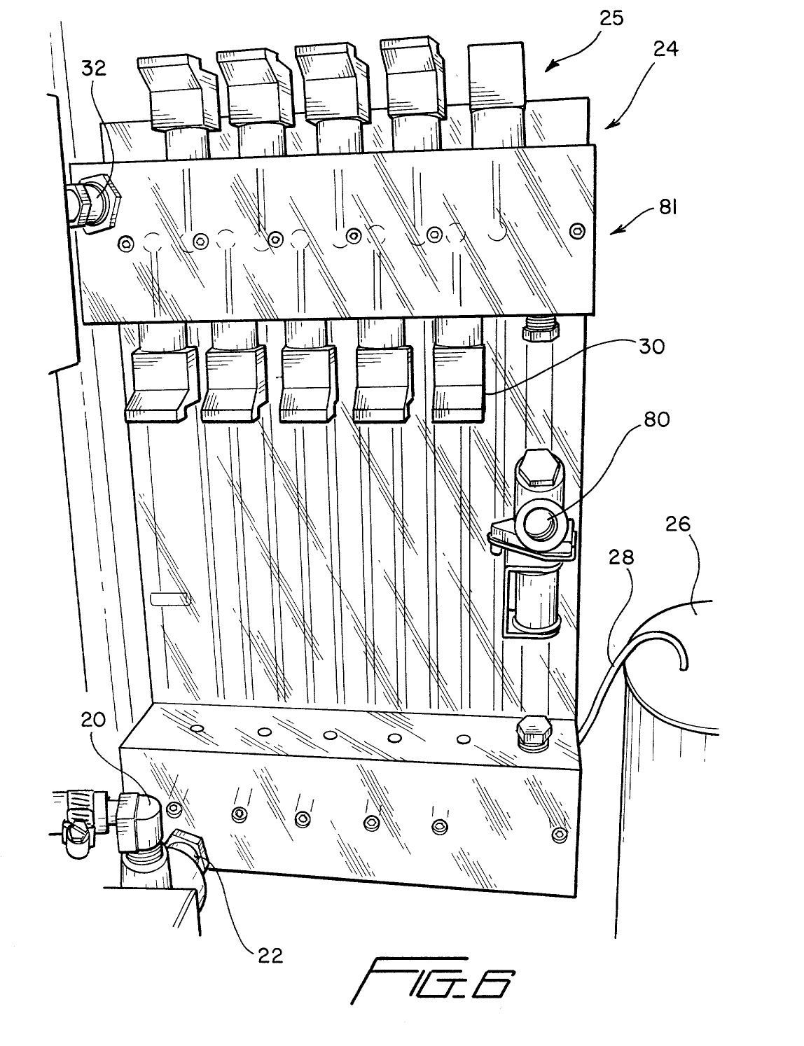

FIG. 9 shows a cross-sectional view of the bottom portion of the manifold 24 with the base channel 90 that has the four large bores 92 and four horizontal channels 94 that intersect the longitudinal channel 90. There are also two end bores 96 that are coincident with the longitudinal channel 90 and a plurality of pulsating solenoids 98 in the four large bores 92 that are adjacent the longitudinal channels.

FIG. 10 shows the end view of a portion of the manifold 24 showing the tap holes 88 that are used to mount the chemical circuit board 25, containing the solenoids and valves used to select the solution called for by the operator to the manifold shown in FIG. 6. The large bore 96, shown in FIG. 10, is capable of receiving the three-way valve 20, which could be a three-way hot-cold valve, with the outlet 22 of the valve being connected to a mixing manifold 24. At least one of the end bores 86 is capable of receiving the spot-free valve 80 or other fluid valve and the other longitudinal channels 82 are capable of receiving the metering valves 30 to control flow through each of the additive supply lines 28.

In the mixing manifold 24 the longitudinal channels 82 contain one or more additive valves 30 that are selectively opened to mix a desired amount of the selected additive with the water entering the manifold. The mixture then leaves the mixing manifold through a delivery line 32 that connects to the suction side 34 of a variable speed pump 36 to supply the mixture to various end.

The longitudinal channels are arranged such that there can be two additive valves 30 in each longitudinal channel 82. Thus it is possible to add ten additives to the above-described embodiment with five longitudinal channels. The sixth longitudinal channel is used to add a fluid, such as spot-free water that can also be mixed with the hot and cold water and the additives as discussed above. In the mixing manifold 24, the various additive valves 30 are selectively opened to mix a desired amount of the selected additive with the water entering the manifold. These additives come from the additive supplies 26 via additive supply lines 28. The additives are in ten containers for the above embodiment, which also have ten additive valves, ten chemical floats, and ten chemicals fill valves in the ten additive containers.

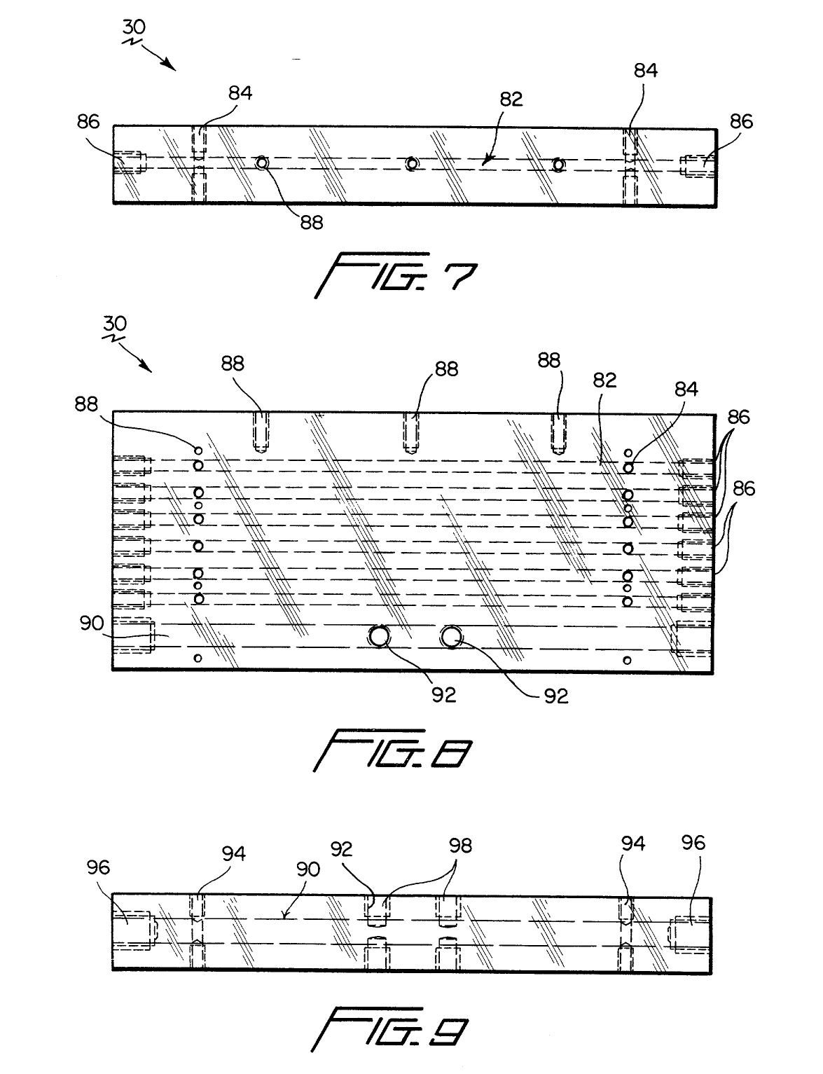

FIG. 11 shows a perspective view of a mixing solution storage container 100 that mixes the additives 26 and water before sending them to the applicator 44. The mixing solution storage container 100 has a stainless steel cover 101 that supports a water solenoid 102 in communication with the water inlet 104 that is protected by a custom suction cap 106. The lid 101 also supports chemical meter tip suction 108 and a PC board 110 for controlling the mixing. The cover could be made of other materials appropriate to the use and chemicals involved, as is well know in the art. The cover attaches, such as with screws, to a mixing container 112, in this case a clear plastic but that could be made of a variety of materials appropriate to the application. The mixing container 112 defines a cavity 114 that can contain chemical probes 116 for detecting the chemical additive 26 and acts as mixed solution storage.

FIG. 12 shows a partial cut away of the top view of the mixing solution storage container cover 106 showing the water supply inlet 104 that is adjacent a fluid solenoid 120 and a metered chemical intake 122. The intake is in communication with a venturi device 124 that is in communication with a water supply through the water supply inlet 104. A water supply line 126 can be an integral part of the cover 106 or adjacent the cover 106. The mixing solution storage container cover 106 also contains an overflow opening 128 and a suction line 130 that communicates to the pump 36 through a supply opening 132 to the pump. The mixing solution storage container cover 106 has a sealing ring 134 to enable a tight fit. This sealing ring can include one or more o-rings.

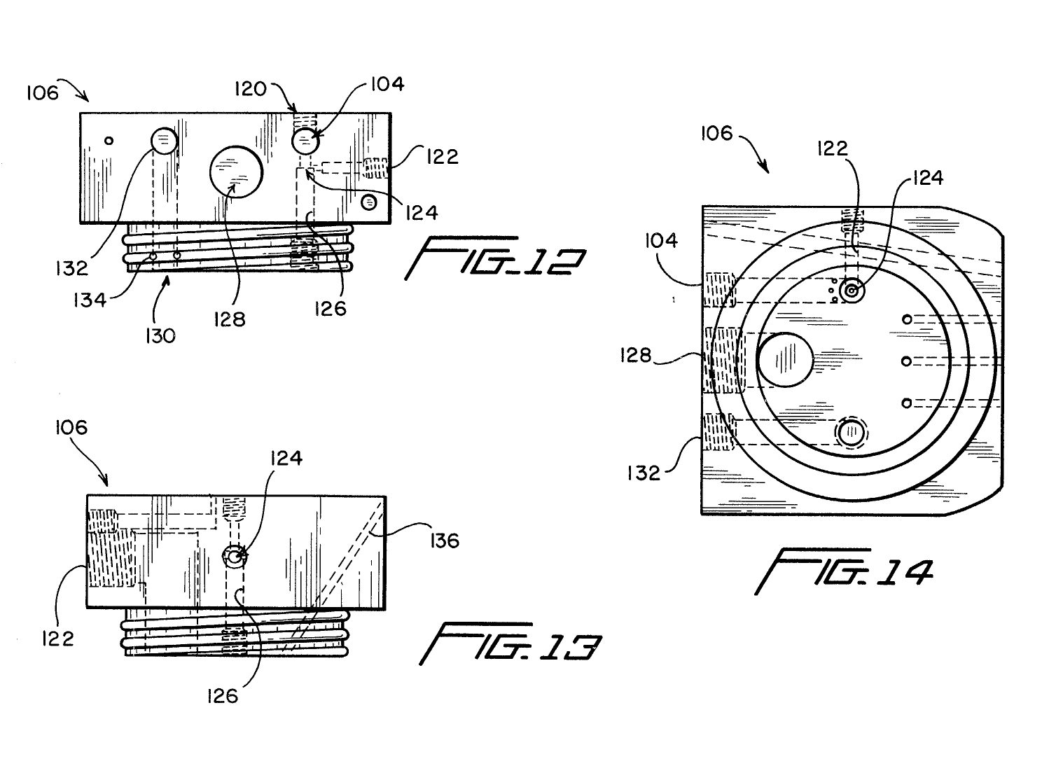

FIG. 13 shows partial cut away side view of the mixing solution storage container cover 106 showing the venturi that sits in the water supply line 126 and communicates with the overflow128 such that metered amounts of additives can enter the water stream. FIG. 13 also shows a stainless steel rod 136 that is set in the mixing solution storage container cover 106 at an angle that allows the operator to measure the mixture fill levels. The measuring rod 136 can be other materials that are appropriate to the chemicals and application as is well known in the art.

FIG. 14 shows a bottom cross-sectional view of the mixing solution storage container cover 106 with the overflow 128, water inlet 104, pump supply outlet 132, chemical inlet 122 and venturi 124 as they set in the mixing container cover 106.

In operation, a user accesses the system by using coins or other means to pay for a desired wash cycle. This process is time-based meaning that it is controlled by the time purchased at the data source 48 and the operator can chose during a free-time period from a selection of items such as a wash cycle, a rinse cycle, a wax cycle or other various items of interest to the operator in conjunction with the cleaning and finishing of the car. After these items are selected the car wash begins so essentially the car wash bay is rented for a period of time.

Alternatively the operator can chose between preset total car wash cycles that are automated to switch from one mode, such as washing, to another mode such as waxing automatically based on various conditions. These preset cycles will activate based on what has been programmed into the computer/controller using appropriate software. There are other criteria, including seasonal variations, weather, water temperature, air temperature, car type, and time of the day as well as other relevant criteria to be used in conjunction with the preset choices and the computer/controller. The controller 46 then operates the particular valves 30 so that an additive can be delivered to the mixing meter 24 in accordance with the selected wash and cycle. The controller also causes operation of the pump 36. The suction created by the pump operating at a selected speed draws water into the mixing manifold along with one or more additives from each of the selected supplies. In the mixing manifold the additives are combined with the water flow. The pump then pumps the mixture under pressure to the applicator 44 selected by the controller 46.

Since additives from the supplies 26 are injected at the suction side of the pump 36, the amount of additives entering the flow stream need to be monitored. This is accomplished in the present invention by the valves 30, which can be solenoid-operated needle valves. The additive suppliers thus are continuously exposed to the reduced pressure at the suction side of the pump and the needle valves are opened as necessary to allow the additives to be drawn into the flow stream. Preferably the needle valves are operated by pulsing the solenoid controlling each valve.

Increasing or decreasing the pump speed to change the output pressure at the applicator 44 also acts to change the low pressure at the suction side of the pump. Accordingly the controller 46 is programmed to increase or decrease the opening of the needle valves as needed to compensate for changes in the suction side pressure and maintain a constant flow of the additive at the desired rates.

The present invention also has a purge feature, which can operate between car washing cycles. such as between the choices that one operator may make. During the purge cycle or feature, the pump runs at fall speed to push out the solution or additives from that former cycle and then fills the lines with new solution and additives. This feature shortens the delay between operator-activated cycles and the delay between products the operator choices during a cycle.

Thus, in accordance with the present invention, there is a single pump for directing flow against the vehicle to be washed. Each of the additive supplies is connected to the suction side of this pump, which eliminates the need for multiple pumps, one for each of the separate additives. Metering valves such as the needle valves described are arranged between each additive supply and the pump for controlling the flow of the additives.

In the claims:

1. A vehicle washing station, comprising:
(a) a pump for selectively producing an output stream, the pump having a reduced pressure inlet side;
(b) a first additive supply;
(c) a second additive supply; and
(d) metering means fluidly intermediate the inlet side and the first and second additive supplies for selectively introducing the first and second additives into an input stream.

2. A vehicle washing station of claim 1 having an operator interface, comprising:
(a) a controller selected to receive instructions from the operator interface;
(b) a frequency drive to control a speed of a motor to which the pump and first and second additive supplies are connected;
(c) a variable output pump assembly connected to the controller, for producing an output corresponding to an instruction from the controller; and
(d) a mixing manifold with additive supply valve.

3. The vehicle washing station of claim 2 having a coin box comprising a program to communicate operator-selected instructions to the pump.

4. The vehicle washing station of claim 2 such that the mixing manifold on the suction side of the pump draws water and chemicals.

5. The vehicle washing station of claim 4 further comprising a pulse solenoid valve to introduce additives to an inlet side fluid stream such that the valve is capable of continually exposing the additive supply valve to the inlet side fluid stream, thus reducing pressure across the valve, the solenoid valve selectively actualable to allow the additive to be drawn into the inlet side fluid stream flow.

6. The vehicle washing station of claim 5, wherein the mixing manifold further comprises a purge system.

7. The vehicle washing station of claim 5, wherein the mixing manifold further comprises a chemical circuit board.

8. The vehicle washing station of claim 6, wherein the mixing manifold has a mixing solution storage container comprising:
(e) a container body defining an mixing storage area;
(f) a container cover supported by the body comprising a sealing device between the cover and the container;
(g) a fill line connected to the cover containing an inlet to the container body;
(h) a venturi device in communication with the fill line and the inlet; and
(i) an outlet from the container.

9. The vehicle washing station of claim 6, further comprising a computer operable connected to the chemical circuit board.

10. The vehicle washing station of claim 8, further comprising an overflow opening in communication with the mixing storage area.

11. A vehicle washing station, comprising:
(a) a pump for selectively producing an output stream, the pump having a reduced pressure inlet side;
(b) a first additive supply;
(c) a second additive supply; and
(d) metering means fluidly intermediate the pump and the first and second additive supplies for selectively introducing the first and second additives into the pump stream.

12. A vehicle washing station of claim 11 having an operator interface, comprising:
(e) a controller selected to receive instructions from the operator interface;
(f) a frequency drive to control speed of a motor to which the pump and additives are connected;
(g) variable output pump assembly connected to the controller, for producing an output corresponding to an instruction from the controller; and
(h) a mixing manifold.

13. The vehicle washing station of claim 12 having a coin box comprising a program to communicate operator-selected instructions to the pump.

14. The vehicle washing station of claim 12 such that the mixing manifold on the suction side of the pump draws water and chemicals.

15. The vehicle washing station of claim 14 further comprising a pulse solenoid valve to introduce additives to the fluid flow such that the valve is capable of continually exposing the additive supply valve to the fluid stream, thus reducing pressure across the valve and then actuating the solenoid to allow the additive to be drawn into the fluid flow.

16. The vehicle washing station of claim 11 where the mixing manifold further comprises a purge system.

17. The vehicle washing station of claim 11 where the mixing manifold has a mixing solution storage container comprising:
(i) a container body defining an mixing storage area;
(j) a container cover supported by the body comprising a sealing device between the cover and the container;
(k) a fill line connected to the cover containing an inlet to the container body;
(l) a venturi device in communication with the fill line and the inlet; and
(m) an outlet from the container.

18. The vehicle washing station of claim 11 further comprising a frame comprising:
(a) a stand;
(b) an upright portion attached to the stand; and
(c) an upper portion attached to the upright portion.

19. The vehicle washing station of claim 18, wherein frame comprises conduit.

20. The vehicle washing station of claim 19, wherein the frame provides fluid communication from the chemical supply to the manifold.

21. A vehicle washing method, comprising:
(a) producing an output stream using a pump having a reduced pressure inlet side;
(b) supplying a first additive supply;
(c) supplying a second additive supply; and
(d) metering the first and second additive supplies fluidly intermediate the pump and selectively introducing the first and second additives into an inlet side stream.

22. The vehicle washing method of claim 21 further comprising drawing the first additive supply and the second additive supply into a mixing manifold on the inlet side of the pump.

23. The vehicle washing method of claim 22 further comprising introducing the additives to the inlet side stream using a pulse solenoid valve by continually exposing the additive supply valve to the fluid stream, thus reducing pressure across the valve and then actuating the solenoid to allow the additive to be drawn into the inlet side stream.

24. The vehicle washing station of claim 22 where providing the mixing manifold with a mixing solution storage container comprising:
(e) a container body defining an mixing storage area;
(f) a container cover supported by the body comprising a sealing device between the cover and the container;
(g) a fill line connected to the cover containing an inlet to the container body;
(h) a venturi device in communication with the fill line and the inlet; and
(i) an outlet from the container.

25. The vehicle washing station of claim 22 further comprising providing an overflow opening in communication with the mixing storage area.

26. A mixing solution storage container, comprising:
(a) a container body defining an mixing storage area;
(b) a container cover supported by the body comprising a sealing device between the cover and the container;
(c) a fill line connected to the cover containing an inlet to the container body;
(d) a venturi device in communication with the fill line and the inlet; and
(e) an outlet from the container.

27. The vehicle washing of claim 26 further comprising an overflow opening in communication with the mixing storage area.
